(19) United States
(12) Patent Application Publication
(10) Pub. No.: US 2021/0109980 A1
(43) Pub. Date: Apr. 15, 2021

(54) Website-Lifecycle Management Tool

(71) Applicant: Stackbit Inc, Claymont, DE (US)

(72) Inventors: Ohad Eder-Pressman, Claymont, DE (US); Simon Hanukaev, Claymont, DE (US); Dan Barak, Claymont, DE (US)

(73) Assignee: Stackbit Inc, Claymont, DE (US)

(21) Appl. No.: 17/071,730

(22) Filed: Oct. 15, 2020

Related U.S. Application Data
(60) Provisional application No. 62/915,440, filed on Oct. 15, 2019.

(51) Int. Cl. G06F 16/958; G06F 16/957; G06F 3/0486; G06F 16/954

(52) U.S. Cl. CPC G06F 16/958; G06F 16/954; G06F 3/0486; G06F 16/9577

(57) ABSTRACT

Disclosed are systems and methods for an in-context, website-lifecycle management tool that may be directly overlayed onto or in proximity to a website, wherein the management tool controls and manages the entirety of the website content's lifecycle and/or workflows. The management tool operates independently of any underlying or pre-existing providers or data sources used to generate, maintain, and/or store the webpage and/or website content. Accordingly, implementations and embodiments herein of the management tool provides a consistent website-management and/or editing tool for facilitating the maintenance of a website, where the management tool is independent of and separate from the data sources used to build the website.

### CROSS-REFERENCE TO RELATED APPLICATION(S)

This application claims benefit to U.S. Provisional Application No. 62/915,440, filed on Oct. 15, 2019, titled “WEBSITE LIFECYCLE MANAGEMENT WIDGET AGNOSTIC TO TOOLS,” the contents all of which are incorporated herein by this reference as though set forth in their entirety, and to which priority and benefit are claimed.

### TECHNICAL FIELD

The present application relates generally to website-management tools, and more specifically to methods and systems for direct management of a website's content and lifecycle that are independent of and separate from the website's original data and functionality sources.

### BACKGROUND

Existing technology allows for the relatively simple creation of websites by almost any individual. For example, users without any coding experience may use services offering drag-and-drop features to build and edit websites. Conventionally, once a website is built, only the technology originally used to create it can be used to further maintain the website. This is generally true regardless of whether the website was recently built with sophisticated technology or is a legacy website that has existed for some time. As a result, any changes to an existing website must be directly done either through coding or through the website-management applications specialized for the website's underlying technology. Such applications often require individualized mechanisms for facilitating website-lifecycle management (e.g., publishing and editing operations).

However, this restricts and narrows the management tools available to specific technology stacks and makes it impossible to edit a website without directly accessing the original, underlying technology. For example, if a website is built on platform X, it requires the management tools of platform X to further manage and edit the site—the management tools of platform Y are insufficient. This causes significant and limiting aspects for managing and editing websites. And it can inhibit the efficient migration of websites to different platforms and technology stacks. Overall, it limits the technology available to website owners for managing their websites and impedes the flexibility to make optimal decisions pertaining to how a website is implemented, hosted, edited, and—ultimately—controlled.

Thus, what is needed is a website-lifecycle management tool that can manage existing websites regardless of the original provider. Such a tool will overcome existing restrictions on website management by allowing for an application that operates independently of the specific technologies originally used to provide content and website-generation functionality. This will provide benefits that the state of the art cannot currently provide.

### SUMMARY OF THE DISCLOSURE

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

According to some possible implementations, disclosed herein are systems and method comprising receiving, by a device, a source file from a website data source, wherein the source file comprises an original format wherein the original format is compatible with the website data source, wherein the source file is associated with generation of a website via a content delivery network and wherein the website comprises at least one webpage; generating, by the device and based on receiving the source file, a rendering of a website preview pane; converting, by the device and based on receiving the source file, the original format of the received source file to a normalized format source file; generating, by the device and based on converting the source file to a normalized format source file, a rendering of a user-interface editing control, wherein the user-interface editing control is associated with the website; displaying, by the device and based on generating the rendering of the website preview pane, the website preview pane; and displaying, by the device and based on generating the rendering of the user-interface editing control, the rendered user-interface editing control in proximity to the displayed website preview pane.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As will be realized, the present disclosure is capable of other different embodiments and its several details are capable of modifications in various other embodiments all without departing from, or limiting, the scope herein.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIGS. 1A-1C are diagrams of an example implementation described here.

FIGS. 2A-2B are diagrams of an example environment in which systems and/or methods, described herein, may be implemented.

FIG. 3 is a diagram of example components of one or more devices of FIGS. 2A-2B.

FIG. 4 is a flowchart of an example process for a computer system for facilitating direct webpage editing.

### DETAILED DESCRIPTION

The following detailed description of example implementations refers to the accompanying drawings. The same reference numbers in different drawings may identify the same or similar elements. Before the present methods and systems are disclosed and described, it is to be understood that the methods and systems are not limited to specific methods, components, or to particular implementations. It is also to be understood that the terminology used herein is for the purpose of describing particular embodiments only and is not intended to be limiting. Various implementations are described with reference to the drawings. In the following description, for purposes of explanation, numerous specific details are set forth in order to provide a thorough understanding of one or more implementations. It may be evident, however, that the various implementations and embodiments may be practiced without these specific details. In other instances, well-known structures and devices are shown in block diagram form to facilitate describing these implementations.

Websites may be created through the use of any number of providers, services, and applications that allow for a streamlined, user-friendly approach to website creation. For example, a third-party service provider may host the website and provide all contents, themes, and/or interactions necessary for the efficient creation and subsequent operation of the website (e.g., headless-CMS (content management system)). A service provider (e.g., continuous deployment) may fetch a website's source code and trigger the website-generation process that obtains the content from the headless-CMS service and generates a website. Once the website is generated, that service provider deploys it to another service provider (e.g., content delivery network) that publishes and hosts the website.

However, the vast number of providers and applications create significant issues if a website is to be maintained or controlled in an environment separate from and independent of the original underlying technology used to create and maintain it (referred to herein as “Provider” for ease of reference). This is because each provider or application employs its own content and components to carry out functions, such as hosting or operating content management systems. And any changes to a website—e.g., hosting, content-manipulation, editing, or controlling—must be done through those specific components and Providers. Without adequate methods and systems for managing and controlling a website content's lifecycle and/or workflows independent of the original, underlying Provider, control of the website is drastically limited.

Some implementations described herein allow for a single in-context, website-lifecycle management tool (“In-Context Tool”) directly overlayed to some degree on the website, that controls and manages the entirety of the website content's lifecycle and/or workflows. The In-Context Tool may operate independently of any underlying or pre-existing Providers used to generate, maintain, and/or store the webpage and/or website content. Accordingly, implementations and embodiments herein of the In-Context Tool may provide a consistent website-management and/or editing tool for facilitating the maintenance of a website, where the In-Context Tool is independent of and separate from the Providers used to build the website.

The In-Context Tool may be displayed on top of or alongside the website. In some implementations, the In-Context Tool may be injected into the website and displayed on top of the website in manner by which it is presented to be a component or addition of the website itself. In some implementations the website itself may be embedded inside the In-Context Tool such that the In-Context Tool is displayed alongside the website.

In some implementations described herein, the In-Context Tool may comprise functionality options (e.g., user-interface controls or editing capabilities) for managing a webpage, website lifecycle, and/or workflows. In some implementations, the functionality options may be derived from the Provider and resemble or mirror the functionality options of the Provider. For example, in one embodiment, the In-Context Tool may display the editing controls of the Provider along with the original data and functionality of the Provider.

In some implementations, the In-Context Tool may enable editing of a website's content directly on the website—without requiring determination of the Provider's location—and provide for immediate changes to the content. Such editing may be done regardless of the Provider, and regardless of whether the Provider for a subset of content is distinguishable from the Provider of some other subset of content. For example, despite the website's title being stored in a headless content management system and the website's blog-post preview originating from a third-party document or from the website source code, the In-Context Tool may enable editing of both the title and blog-post preview without any variation in user experience.

In some implementations, the In-Context Tool may operate as a gateway for making content changes in the Provider. For example, in some implementations, the In-Context Tool may continually communicate with the Provider so as to pull and obtain updates and edits from the Provider and upload it to the website. In other implementations, the In-Context Tool may generate a preview of the changes by pulling the most up-to-date content from the Provider; enabling the option to allow such changes to be published on the live website.

In some implementations, the In-Context Tool may generate previews of the website with the most-current content pulled in from all Providers. Such previews may comprise shareable links and may operate in several modes (mutually inclusive). For example, in one embodiment, previews may be displayed in real-time and snapshot previews. Real-time previews may comprise a display of the most-current content obtained from all Providers and the In-Context Tool. Whereas a snapshot preview may comprise a display of the content existing at the time the preview was generated, regardless of the Provider(s). In some embodiments, viewing a snapshot link may reflect the content state at the time of generation regardless if new content has since become available or published.

In some implementations, previews may be displayed regardless of the In-Context Tool being logged into or not. In some embodiments, accessibility may be limited depending on users being logged or not. For example, the In-Context Tool may restrict a logged-out user's access to content and/or functionalities.

In some implementations, the In-Context Tool may generate preview links that may exist for an indefinite duration of time and be available for viewing as such. Or the generated preview links may comprise a finite duration of time, such as an expiration date, wherein the link is no longer viewable after the time period expires. Generated preview links may be deleted and revoked.

In some implementations, a website's content may undergo a web-design workflow process: once content has been created, edited, or changed, it may go through several defined paths before being published on a live site. The In-Context Tool may support these workflows while being separate from and independent of the Providers. In so doing, the In-Context Tool may take into account the aggregated end-result. For example, when publishing occurs, each of the Providers feeding the page may be updated according to its needs and specifications (e.g., content is published, a version is saved, etc.). In some embodiments, based on pre-defined roles for the In-Context Tool's users, the In-Context Tool may move the content through its workflows by prompting the relevant users/roles in each workflow.

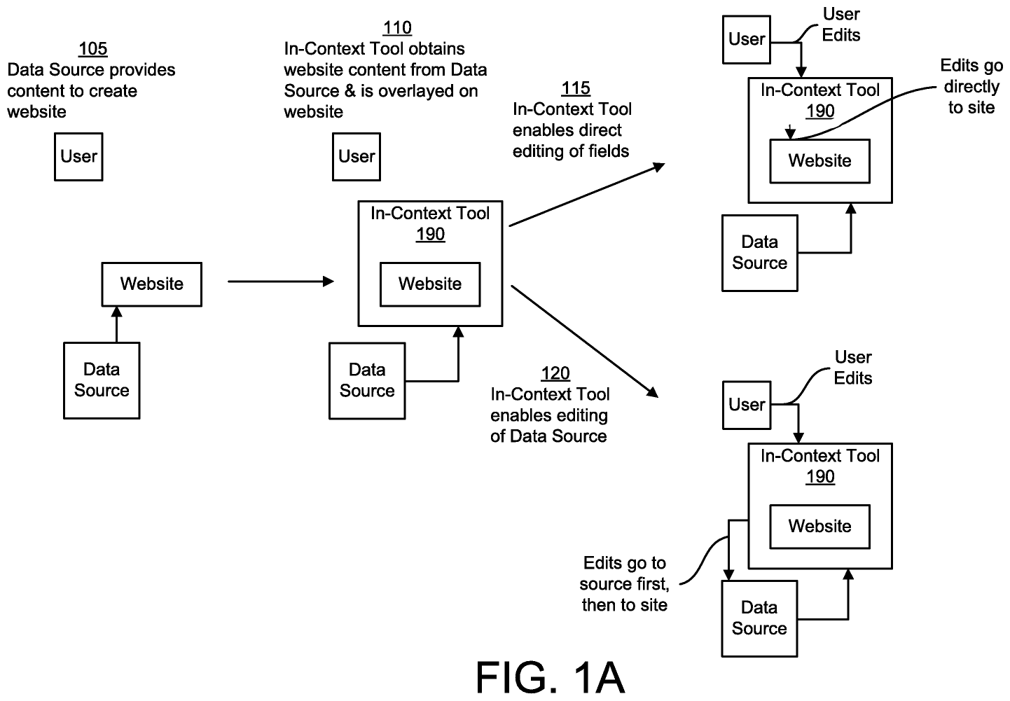

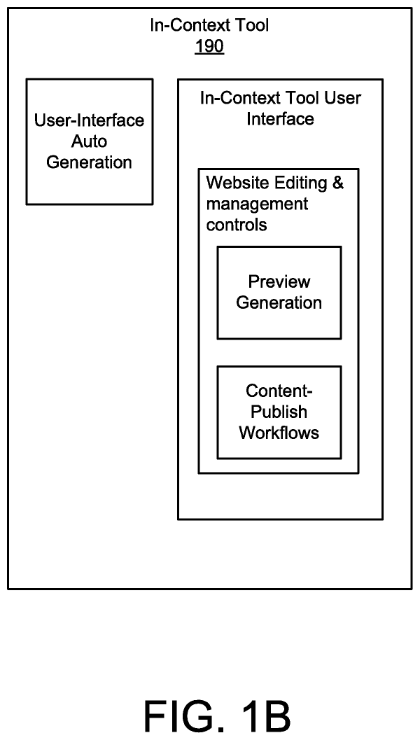

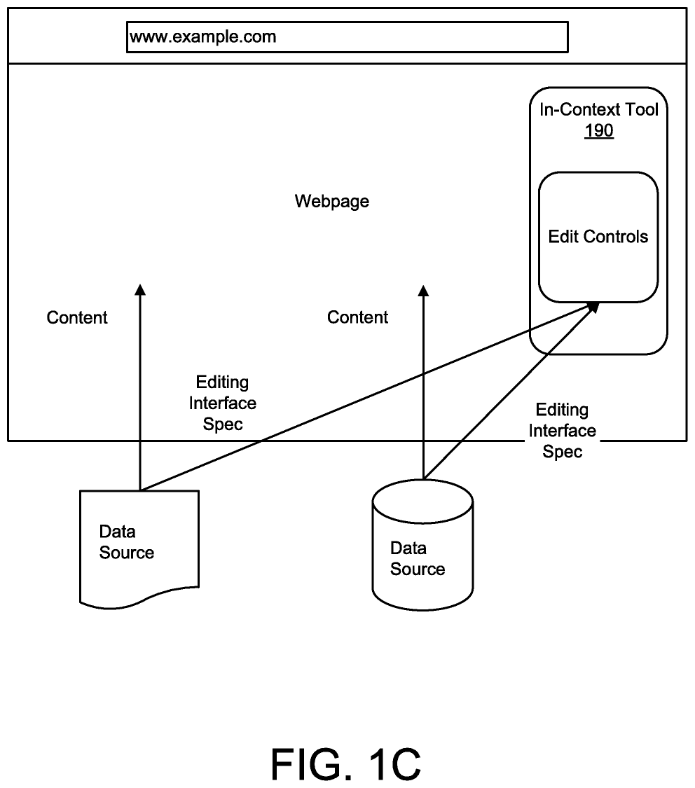

FIGS. 1A-1C are diagrams of an example implementation described here.

As shown in FIG. 1A, the In-Context Tool 190 may enable the editing and management of a website that is independent of one or more Providers. As shown by reference number 105, a Provider, designated in FIG. 1A as “Data Source,” may provide the content and website-generation functionality necessary to create and maintain operation of a website. The Providers may comprise content management Systems (CMS), databases, source files, data files, page template files, and digital asset management systems.

As shown by reference number 110, the In-Context Tool 190 may obtain the website's content, website-management capabilities, and any other data necessary to manage and operate the website. The process for fetching the source data is defined by the website's source code and the website generation process. The In-Context Tool is independent of the data-fetching mechanism. Upon obtaining data from the Provider, the In-Context Tool 190 may be overlayed over the website. The In-Context Tool may also be displayed alongside the website. In some implementations, the In-Context Tool may be injected into the website and displayed on top of the website in manner by which it is presented to be a component or addition of the website itself. In some implementations the website itself may be embedded inside the In-Context Tool such that the In-Context Tool is displayed alongside the website.

In some embodiment, the In-Context Tool 190 may extend around the outside perimeter of the website. Yet in other embodiments, the In-Context Tool 190 may be displayed, positioned, or oriented in any number of locations relative to the website's position.

As shown by reference number 115, the In-Context Tool 190 may enable direct in-place editing of the website's fields. For example, the In-Context Tool 190 may receive data input from a user and generate the input directly onto the website.

As shown by reference number 120, the In-Context Tool 190 may enable editing of the content in the Provider, wherein the edits to the Provider is then generated directly onto the website. In some implementations, the In-Context Tool 190 allows for direct user-editing of the website via the In-Context Tool's user interface. The In-Context Tool 190 transfers all user-updated data to the original data source/provider. Once saved there, the Provider notifies the website generator, which triggers regeneration of the website and automatically updates the website in user's browser.

In some implementations, the In-Context Tool 190 may enable editing to the website both through direct editing 115 and through the Provider 120. In other implementations, editing by the In-Context Tool 190 may depend on the types of Providers. For example, editing functionalities may depend on the API provided by each Provider (e.g., if the Provider provides read-only APIs, then the In-Context tool is only able to show existing content but not edit it directly).

User of the In-Context Tool 190 to edit a website enables modification and publication of existing website-content data regardless of the Provider (i.e., technology stack, content source, and website-generation system) used to build and service the data. The In-Context Tool 190 may function as a one-stop shop by receiving data input from a user or device and implementing the data (the edits/changes) either directly to the website or through the Provider. The In-Context Tool 190 reduces the number of computer-implemented steps, user actions, and data-inputs necessary to edit and manage a website. The In-Context Tool 190 provides a more efficient computer system by reducing the number of systems necessary to edit and manage a website. The In-Context Tool 190 also facilitates managing a website by a user and/or device because managing the website does not require direct access, manipulation, or use of the Provider. In some implementations, a user is not required to go to the Provider to make changes and doesn't have to go through the Provider used to build or is otherwise servicing the website. Use of the In-Context Tool 190 that enables bypassing the Provider enables a website to operate more efficiently and faster: the direct-editing capabilities of the In-Context tool provides immediate display and feedback of the updated data. For example, every change to the data is quickly and automatically reflected in the browser—removing the need to switch between browser tabs or wait for service providers to build the site.

In some implementations, the In-Context Tool 190 may generate abstraction layers, such as abstraction of Providers and their API differences to fetch and save content, or abstraction of website-generation systems and their APIs to re-generate and automatically update browser with website preview that strategically obscures underlying complexities of the content and/or website generation system of a Provider. The In-Context Tool 190 may further enable user-modification of webpage content directly in place, while further enabling virtually instantaneous viewing the results of any such modifications, without requiring the user to know the source of the content.

As shown in FIG. 1B, the In-Context Tool 190 may comprise one or more components for the purpose of managing a website independent of and separate from the Provider. In some implementations, the In-Context Tool 190 may comprise one or more of a user-interface automatic generation, an in-context user interface, and website editing and management controls, such as preview-generation capabilities and content-publishing workflow capabilities.

In some implementations, the user-interface automatic generation module of the In-Context Tool 190 may automatically generate an in-context user interface based on information (e.g., editing interface specifications) retrieved from one or more Providers. The Providers may be or include content management systems, databases, or other content sources that may be polled by the user-interface automatic generation module to determine information, e.g., metadata, enabling the user-interface automatic generation system to configure the user interface accordingly. In some implementations, the in-context user interface may mirror, resemble, or recreate the user interface or editing options of the Provider, so as to enable a familiar user experience and/or facilitate use.

The in-context user interface may comprise website editing and lifecycle management controls, such as preview-generation capabilities and content-publishing workflow capabilities. The preview-generation capabilities may enable the generation of website and webpage previews. The content-publishing controls and functionality may enable selectively publishing content to the website in accordance with predetermined workflows, schedules, etc.

In some implementations, the In-Context Tool 190 may implement functionality for providing in-place editing of fields when the content source is a headless content management system, and can also offer a user-interface control (e.g., button, menu item, etc.) to edit the content in its original database location (e.g., Google Doc location).

In some implementations, the In-Context Tool 190 and accompanying in-context user interface may further implement functionality for enabling not just user modification of webpage content directly in place, but also enabling viewing the results of any such modifications virtually instantaneously, without requiring the user to know the source of the content.

In some implementations, the In-Context Tool 190 may provide a gateway for website-content changes, including changes made using all Providers. By selectively communicating with the Providers to obtain information (e.g., editing interface specification data, etc.) therefrom, the In-Context Tool 190 may become aware of any changes in content maintained by the Providers despite which Provider has experienced data changes.

In some implementations, the one or more user-interface controls for generating a preview may further comprise one or more user-interface controls for enabling user viewing of one or more previews of the website with the most recent content from all Providers. The preview may comprise one or more sharable links and may operate in one or more of several modes, such as a real-time mode, a snapshot mode, a time-constrained mode, an indefinite mode, etc. The one or more content-publishing workflows may include the steps of reviewing content, requesting changes for a website, submitting the changes to a person or entity for approval, and scheduling publishing of the website, etc.

In some implementations, the In-Context Tool 190 may extract the most recent (up to date) changes from the providers. This facilitates enabling the In-Context Tool 190 to generate previews (e.g., via the preview-generation module) of the associated changes (responsive to the detected data/content changes) in the website. Previews may be augmented with links that can be shared with others. The previews may also operate in different modes. For example, a real-time preview may reflect the latest content changes from any provider, whether the changes have been made directly in an external provider and/or via use of the widget itself. Furthermore, previews may be saved for subsequent viewing and need not be live previews. Previews may also be assigned an expiration date, such that after the expiration date, the previews are no longer available or viewable. Previews can also be deleted, canceled, or otherwise revoked, thereby empowering users to selectively allow or reject the changes before the changes are reflected in a live website.

Workflows (e.g., the content-publishing workflows) may facilitate content review, requests for changes, requests for approvals, the setting of publishing schedules, and/or other steps or sequences of steps of a particular flow. The in-context user interface may be compatible with specific steps of a workflow for managing the website. The workflows may be implemented via Business Process Execution Language (BPEL) or other suitable technology. Furthermore, the in-context user interface may include controls for facilitating construction of such workflows, where the controls abstract away the complexity of directly coding BPEL flows.

Although the implementations of the In-Context Tool 190 are described herein with respect to particular embodiments thereof, these particular implementations are merely illustrative, and not restrictive. For example, while embodiments are primarily discussed as usable for website-lifecycle managing, in other embodiments, the In-Context Tool 190 may operate with various platforms, regardless of the underlying technologies used by the content-providing platforms. For example, implementation of the In-Context Tool 190 may also facilitate management of other types of documents that rely upon different providers generated by or provided by different technologies.

As shown in FIG. 1C, The In-Context Tool 190 may enable user-modification of webpage content directly in place regardless of the types of Provider and without requiring the user to know the identity or location of the Provider or requiring the user to access or manipulate the Provider. In some implementations, the In-Context Tool 190, such as through its edit controls, may obtain content and data (e.g., editing interface specifications) from one or more Provider without a user having to directly access the Provider. Any changes to the Provider may be automatically uploaded to the website without a user having to directly access the Provider.

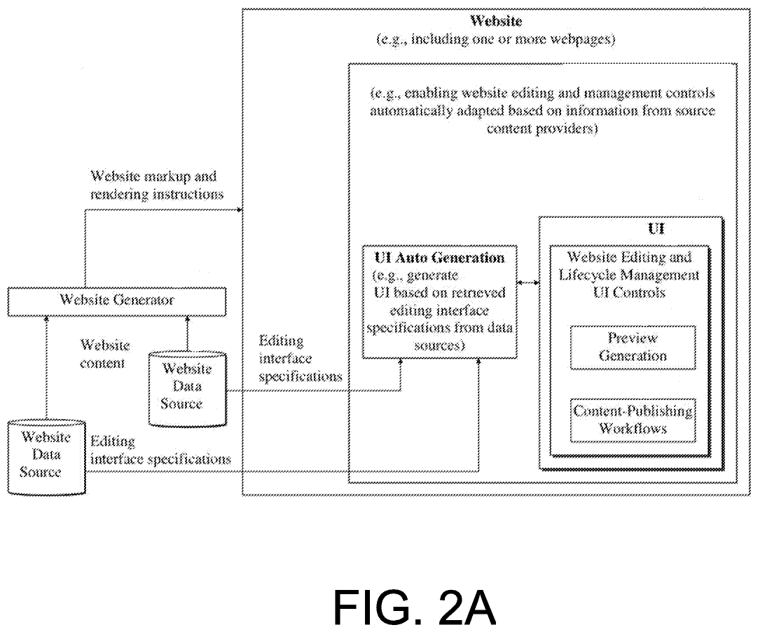

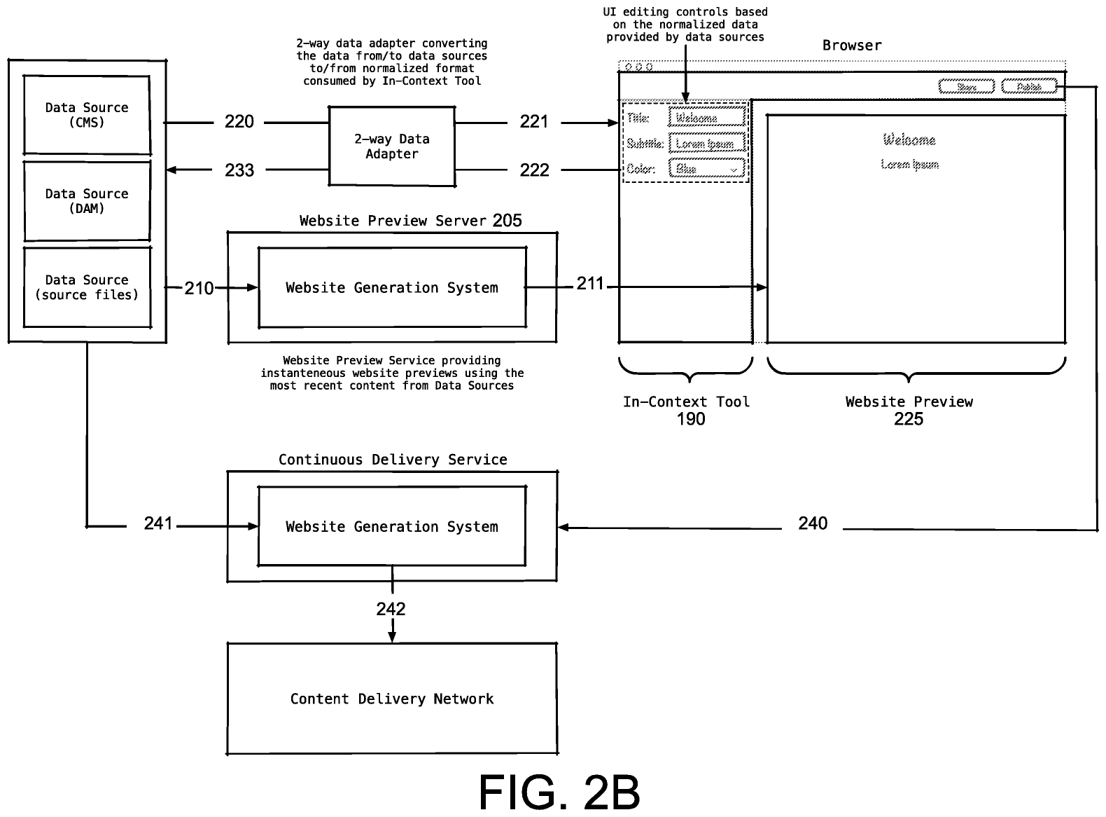

FIGS. 2A-2B are diagrams of an example environment in which systems and/or methods, described herein, may be implemented. As shown in FIG. 2A, some implementations of the In-Context Tool 190 comprises the In-Context Tool 190 displayed and/or overlayed on a website (with one or more web pages), that is usable to manage website lifecycle independently of underlying technologies (e.g., technologies employed by Provider and/or a website generator) used to generate the website.

As shown in FIG. 2B, some implementations of the In-Context Tool 190 comprises the In-Context Tool 190 communicating with one or more systems for the purpose of displaying and/or overlaying the In-Context Tool 190 on a website (with one or more web pages), and which is usable to manage website lifecycle independently of underlying technologies (e.g., technologies employed by Provider and/or a website generator) used to generate the website. In some implementations, the website-preview server 205 loads the source files 210 of a website, including the website generation system (WGS). The website-preview server 205 may then run the WGS that fetches the content from different Data Sources 210, including the content from the underlying source files, to generate the website. The In-Context Tool 190 loads the website served by website-preview server 205 and displays it to the user in a website preview pane 225. In parallel, the In-Context Tool 190 loads data from different Data Sources through a two-way data adapter (Adapter). The Adapter reads data from Data Sources 220 and transforms this data into a normalized format that is consumed 221 by the In-Context Tool 190. With this, the In-Context Tool 190 renders and displays UI editing controls based on the normalized data provided by data sources.

In some implementations, the In-Context Tool 190 receivers edits from a user using the UI editing tools in the form of data input. After receiving this data input, the In-Context Tool 190 sends the edited data to the Data Sources through the Adapter 222, which converts the changed data from the normalized format back to format specific to each Data Source 223. The Data Sources notify WGS of changes in content. WGS fetches the updated data from Data Sources 210 then re-generates the site and automatically updates the website preview 211. In this manner, the In-Context Tool 190 enables a user to continually edit website content.

In some implementations, the In-Context Tool 190 provides for a publishing option 240. When selected, the In-Context Tool 190 triggers a continuous delivery service (CD), which loads the source files of the website 241, including the WGS. The In-Context Tool 190 then runs the WGS that fetches the content from different Data Sources 241, including the content from the underlying source files and generates the website. The CD pushes the artifacts of the generated website to the content delivery network 242, which publishes the website and makes it publicly available.

As shown in FIGS. 2A-2B, groupings of various modules of the In-Context Tool 190 are illustrative and may vary, e.g., certain modules may be combined with other modules or implemented inside of other modules, or the modules may otherwise be distributed differently (than shown) among a network or within one or more computing devices or virtual machines, without departing from the scope of the present teachings. In some implementations, the website may host the In-Context Tool 190. The number of devices and networks shown in FIGS. 2A-2B are provided as an example. In practice, there may be additional devices and/or networks, fewer devices and/or networks, different devices and/or networks, or differently arranged devices and/or networks than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, one or more of the devices of environment may perform one or more functions described as being performed by another one or more devices of environment.

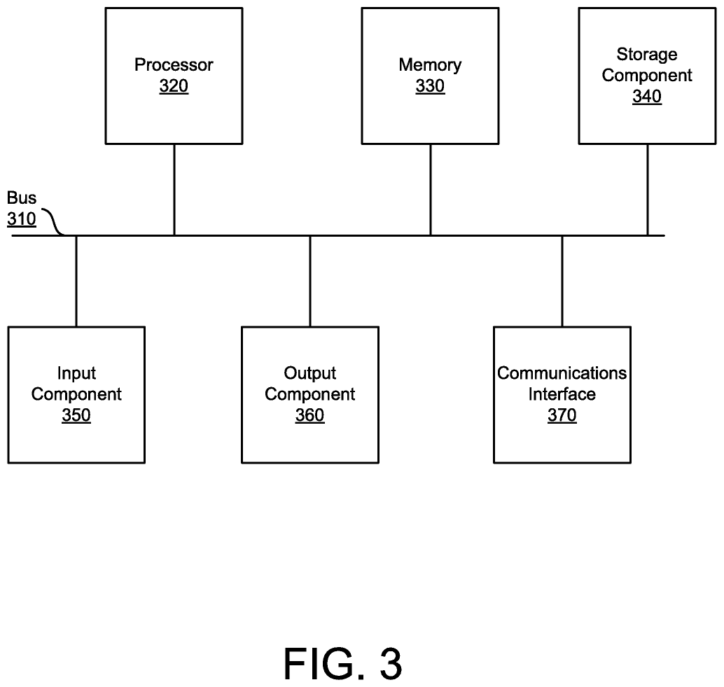

FIG. 3 is a diagram of example component of a device 300. Device 300 may correspond to the implementations of FIGS. 1 and 2. Some implementations may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a filed-programmable gate array (FPGA), an application-specific signal processor (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 includes a component that provides output information from device 300 (e.g., a display, a speaker, one or more light-emitting diodes (LEDs), etc.).

Communication interface 370 includes a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus interface, a Wi-Fi interface, a cellular network interface, or the like.

Device 300 may perform one or more processes described herein. Device 300 may perform these processes in response to processor 320 executing software instructions stored by non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage 340 from another computer-readable medium or from another device via communication interface 370. When executed, software instructions stored in memory 330 and/or storage component 340 may cause processor 320 to perform one or more processes descried herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, few components, different components, or differently arranged components than those shown in FIG. 3. Additionally, or alternatively, a set of components of device 300 may perform one or more functions described as being performed by another set of components of device 300.

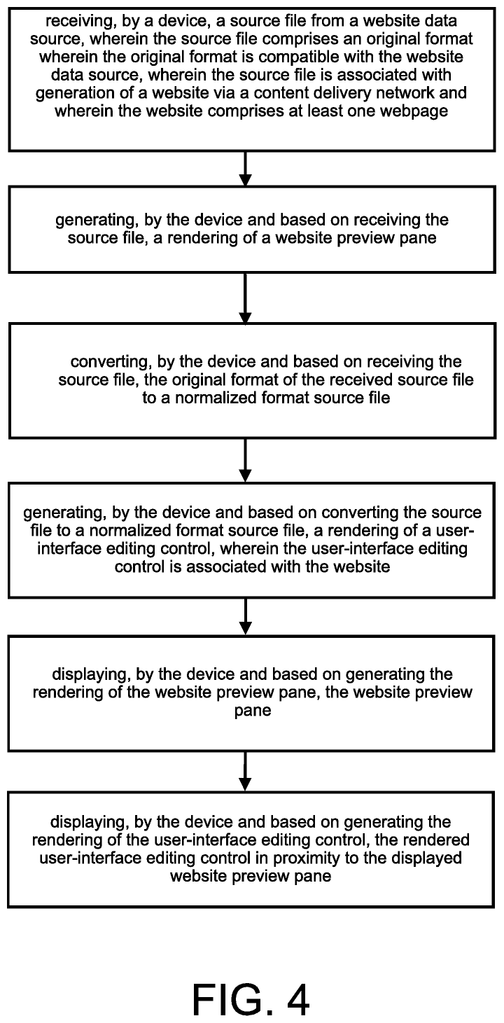

FIG. 4 is a flowchart of an example process for a computer system for facilitating direct webpage editing. In some implementations, the method comprises: receiving, by a device, a source file from a website data source, wherein the source file comprises an original format, wherein the original format is compatible with the website data source, and wherein the source file is associated with generation of a website via a content delivery network and wherein the website comprises at least one webpage. Generating, by the device and based on receiving the source file, a rendering of a website preview pane. Converting, by the device and based on receiving the source file, the original format of the received source file to a normalized format source file. Generating, by the device and based on converting the source file to a normalized format source file, a rendering of a user-interface editing control, wherein the user-interface editing control is associated with the website. Displaying, by the device and based on generating the rendering of the website preview pane, the website preview pane; and displaying, by the device and based on generating the rendering of the user-interface editing control, the rendered user-interface editing control in proximity to the displayed website preview pane.

Although FIG. 4 shows example blocks of process, in some implementations, process may include additional blocks, fewer blocks, different blocks, or differently arranged blocks than those depicted in FIG. 4. Additionally, or alternatively, two or more of the blocks of process may be performed in parallel. In other implementations, FIG. 4 may be a flowchart of an example process for a non-transitory computer readable storage medium storing executable computer program instructions for facilitating direct webpage editing, the computer program instructions comprising instructions that when executed cause a computer processor to: receive, by the computer processor, a source file from a website data source, wherein the source file comprises an original format wherein the original format is compatible with the website data source, and wherein the source file is associated with generation of a website via a content delivery network and wherein the website comprises at least one webpage. Generate, by the computer processor and based on receiving the source file, a rendering of a website preview pane. Convert, by the computer processor and based on receiving the source file, the original format of the received source file to a normalized format source file. Generate, by the computer processor and based on converting the source file to a normalized format source file, a rendering of a user-interface editing control, wherein the user-interface editing control is associated with the website. Display, by the computer processor and based on generating the rendering of the website preview pane, the website preview pane; and display, by the computer processor and based on generating the rendering of the user-interface editing control, the rendered user-interface editing control in proximity to the displayed website preview pane.

In some implementations, FIG. 4 is a flowchart of an example process for a computer system for facilitating direct webpage editing, the system comprising: receiving, by a device, a source file from a website data source, wherein the source file comprises an original format wherein the original format is compatible with the website data source, and wherein the source file is associated with generation of a website via a content delivery network and wherein the website comprises at least one webpage. Generating, by the device and based on receiving the source file, a rendering of a website preview pane. Converting, by the device and based on receiving the source file, the original format of the received source file to a normalized format source file. Generating, by the device and based on converting the source file to a normalized format source file, a rendering of a user-interface editing control, wherein the user-interface editing control is associated with the website. Displaying, by the device and based on generating the rendering of the website preview pane, the website preview pane; and displaying, by the device and based on generating the rendering of the user-interface editing control, the rendered user-interface editing control in proximity to the displayed website preview pane.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

Embodiments of the systems and methods are described with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

Other embodiments may comprise overlay features demonstrating relationships between one more steps, active users, previous users, missing steps, errors in the workflow, analytical data from use of the workflow, future use of the workflow, and other data related to the workflow, users, or the relationship between the workflow and users.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order; it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

What is claimed:

1. A computer-implemented method for facilitating direct webpage editing, the method comprising:
receiving, by a device, a source file from a website data source,
wherein the source file comprises an original format wherein the original format is compatible with the website data source,
wherein the source file is associated with generation of a website via a content delivery network and wherein the website comprises at least one webpage;
generating, by the device and based on receiving the source file, a rendering of a website preview pane;
converting, by the device and based on receiving the source file, the original format of the received source file to a normalized format source file;
generating, by the device and based on converting the source file to a normalized format source file, a rendering of a user-interface editing control, wherein the user-interface editing control is associated with the website;
displaying, by the device and based on generating the rendering of the website preview pane, the website preview pane; and
displaying, by the device and based on generating the rendering of the user-interface editing control, the rendered user-interface editing control in proximity to the displayed website preview pane.

2. The method of claim 1, further comprising:
receiving, by the device, data input, wherein the data input is inputted into the user-interface editing control and wherein the data input corresponds to a change to the normalized format source file.

3. The method of claim 2, further comprising:
providing, by the device and based on the data input, the normalized format source file to the website data source for the purpose of the website data source converting the normalized format source file to the original format.

4. The method of claim 2, further comprising:
rendering and displaying, by the device, a publishing option;
receiving, by the device, an input selection of the publishing option;
generating, by the device and based on receiving the input selection of the publishing option, a continuous delivery service;
loading, by the device and based on generating the continuous delivery service, the normalized format source files;
transferring, by the device and based on loading the normalized format source files, to the content delivery network for the purpose of generating the website.

5. The method of claim 1, wherein the source file comprises one or more of a content management system, a database, a data file, a page-template file, and a digital asset management system.

6. The method of claim 1, wherein the user-interface editing control comprises capabilities for compatibility with a workflow for managing the website and wherein the user-interface editing control comprises one or more controls for facilitating construction of such workflows; the method further comprising:
implementing, by the device, the workflow via a business process execution language.

7. A non-transitory computer readable storage medium storing executable computer program instructions for facilitating direct webpage editing, the computer program instructions comprising instructions that when executed cause a computer processor to:
receive, by the computer processor, a source file from a website data source,
wherein the source file comprises an original format wherein the original format is compatible with the website data source,
wherein the source file is associated with generation of a website via a content delivery network and wherein the website comprises at least one webpage;
generate, by the computer processor and based on receiving the source file, a rendering of a website preview pane;
convert, by the computer processor and based on receiving the source file, the original format of the received source file to a normalized format source file;
generate, by the computer processor and based on converting the source file to a normalized format source file, a rendering of a user-interface editing control, wherein the user-interface editing control is associated with the website;
display, by the computer processor and based on generating the rendering of the website preview pane, the website preview pane; and
display, by the computer processor and based on generating the rendering of the user-interface editing control, the rendered user-interface editing control in proximity to the displayed website preview pane.

8. The computer readable medium of claim 7, wherein the computer program instructions for facilitating direct webpage editing further comprise instructions that when executed cause the computer processor to:
receive, by the computer processor, data input, wherein the data input is inputted into the user-interface editing control and wherein the data input corresponds to a change to the normalized format source file.

9. The computer readable medium of claim 8, wherein the computer program instructions for facilitating direct webpage editing further comprise instructions that when executed cause the computer processor to:
provide, by the computer processor and based on the data input, the normalized format source file to the website data source for the purpose of the website data source converting the normalized format source file to the original format.

10. The computer readable medium of claim 7, wherein the computer program instructions for facilitating direct webpage editing further comprise instructions that when executed cause the computer processor to:
render and display, by the computer processor, a publishing option;
receive, by the computer processor, an input selection of the publishing option;
generate, by the computer processor and based on receiving the input selection of the publishing option, a continuous delivery service;
load, by the computer processor and based on generating the continuous delivery service, the normalized format source files;
transfer, by the computer processor and based on loading the normalized format source files, to the content delivery network for the purpose of generating the website.

11. The computer readable medium of claim 7, wherein the source file comprises one or more of a content management system, a database, a data file, a page-template file, and a digital asset management system.

12. The computer readable medium of claim 7, wherein the user-interface editing control comprises capabilities for compatibility with a workflow for managing the website and wherein the user-interface editing control comprises one or more controls for facilitating construction of such workflows, and wherein the computer program instructions for facilitating direct webpage editing further comprise instructions that when executed cause the computer processor to: implement, by the computer processor, the workflow via a business process execution language.

13. A computer system for facilitating direct webpage editing, the system comprising:
receiving, by a device, a source file from a website data source,
wherein the source file comprises an original format wherein the original format is compatible with the website data source,
wherein the source file is associated with generation of a website via a content delivery network and wherein the website comprises at least one webpage;
generating, by the device and based on receiving the source file, a rendering of a website preview pane;
converting, by the device and based on receiving the source file, the original format of the received source file to a normalized format source file;
generating, by the device and based on converting the source file to a normalized format source file, a rendering of a user-interface editing control, wherein the user-interface editing control is associated with the website;
displaying, by the device and based on generating the rendering of the website preview pane, the website preview pane; and
displaying, by the device and based on generating the rendering of the user-interface editing control, the rendered user-interface editing control in proximity to the displayed website preview pane.

14. The system of claim 13, further comprising:
receiving, by the device, data input, wherein the data input is inputted into the user-interface editing control and wherein the data input corresponds to a change to the normalized format source file.

15. The system of claim 14, further comprising:
providing, by the device and based on the data input, the normalized format source file to the website data source for the purpose of the website data source converting the normalized format source file to the original format.

16. The system of claim 14, further comprising:
rendering and displaying, by the device, a publishing option;
receiving, by the device, an input selection of the publishing option;
generating, by the device and based on receiving the input selection of the publishing option, a continuous delivery service;
loading, by the device and based on generating the continuous delivery service, the normalized format source files;
transferring, by the device and based on loading the normalized format source files, to the content delivery network for the purpose of generating the website.

17. The system of claim 13, wherein the source file comprises one or more of a content management system, a database, a data file, a page-template file, and a digital asset management system.

18. The system of claim 13, wherein the user-interface editing control comprises capabilities for compatibility with a workflow for managing the website and wherein the user-interface editing control comprises one or more controls for facilitating construction of such workflows; the method further comprising:
implementing, by the device, the workflow via a business process execution language.
